(19) United States
(12) Patent Application Publication
(10) Pub. No.: US 2024/0327272 A1
(43) Pub. Date: Oct. 3, 2024

(54) GLASS SHEET COMPRISING A COATING APPLIED IN AT LEAST ONE REGION OF AT LEAST ONE SIDE OF THE GLASS SHEET, LAMINATE COMPRISING SUCH AND PASTE FOR PRODUCING SUCH A GLASS SHEET

(71) Applicants: Schott AG, Mainz (DE); SCHOTT Technical Glass Solutions GmbH, Jena (DE)

(72) Inventors: Stephanie Mangold, Mainz (DE); Yvonne Menke-Berg, Mainz (DE); Martin Spier, Mainz (DE); Hubert Wieseke, Jena (DE)

(73) Assignees: Schott AG, Mainz (DE); SCHOTT Technical Glass Solutions GmbH, Jena (DE)

(21) Appl. No.: 18/621,498

(22) Filed: Mar. 29, 2024

(30) Foreign Application Priority Data
Mar. 29, 2023 (DE) 10 2023 107 996.4

(51) Int. Cl. C03C 17/00; C03C 17/22; C03C 17/32

(52) U.S. Cl. CPC C03C 17/009; C03C 17/007; C03C 17/22; C03C 17/32; C03C 2217/425; C03C 2217/475; C03C 2217/485

(57) ABSTRACT

A glass sheet includes a glass including SiO₂ and B₂O₃ and at least one coating applied in at least one region of at least one side of the glass sheet. The at least one coating includes at least one binder including SiO₂ and at least one pigment. The at least one coating includes less than 500 ppm of Bi₂O₃ and/or less than 500 ppm of ZnO and/or less than 500 ppm of B₂O₃ and/or less than 500 ppm of an alkali metal oxide, based in each case on weight.

### CROSS REFERENCE TO RELATED APPLICATIONS

This application claims priority to German Patent Application No. DE 10 2023 107 996.4 filed on Mar. 29, 2023, which is incorporated in its entirety herein by reference.

### BACKGROUND OF THE INVENTION

### 1. Field of the Invention

The present disclosure relates generally to glass sheets, more particularly regionally coated glass sheets, which may be used, for example, for a vehicle, and to a laminate comprising such a glass sheet and to a paste for producing such a glass sheet. This glass sheet comprises a glass comprising SiO₂ and B₂O₃. More particularly, therefore, the present disclosure also relates to glass sheets composed of or comprising borosilicate glass.

### 2. Description of the Related Art

Glass sheets composed of or comprising borosilicate glasses, particularly including those with at least regional coating, have already been known for a long time and are used for example as viewing windows in oven doors. The advantages of the borosilicate glass here are its thermal integrity in comparison to conventional soda-lime glasses, meaning that viewing windows for pyrolysis furnaces, for example, frequently comprise borosilicate glass sheets of these kinds. Borosilicate glass sheets of these kinds may also be used as cover plates for cooking appliances, and may also be referred to, for example, as a cooking plate or cooking surface.

For other applications, however, borosilicate glasses may also be advantageous, since such glasses have inherent advantages in terms, for example, of scratch resistance or mechanical integrity in general and also chemical integrity relative to the known soda-lime glasses. Increasingly, therefore, borosilicate glass sheets of these kinds are also being used in windscreens.

It is known practice in the external glazing of vehicles to make use, for example, of borosilicate glass, of the kind available commercially, for example, under the trade name Borofloat®. A glass of this kind is exceptionally suitable, for example, for laminated glazing systems and is distinguished by very high transmission in the region of visible light. Moreover, such borosilicate glasses possess very good heat resistance, high chemical integrity, and good mechanical strength.

For example, international patent application WO 2015/059406 A describes laminated glass sheets. One of these sheets may comprise for example a borosilicate glass; for example, the outer sheet.

International patent application WO 2017/157660 A1 describes a laminated glass sheet for a head-up display. Here again, one of the sheets of the laminated glass may comprise borosilicate glass.

CO 2017/0005596 A1 likewise describes a pane of car glass that is of high integrity.

International patent application WO 2019/130285 A1 describes a laminate featuring high resistance towards abrasion and environmental effects.

Lastly, international patent application WO 2018/122769 A1 describes a laminate of high breaking strength.

For the safety of the vehicle occupants, windscreens are configured as laminated glass sheets and typically have a coating in the edge region. This coating serves both for visual concealment of, for example, adhesive bonds or components, such as aerials, for example, and also for protection thereof from UV radiation. This border is generally arranged between the two glass sheets of a laminate. Additionally, the laminate further comprises a polymeric ply, i.e. a ply between the two glass sheets that comprises a polymer or consists of a polymer and that joins the glass sheets to one another. The glass sheets with the coating arranged between them in at least one region, in particular in the edge region, are placed on top of one another and bent in a thermal forming process. A polymeric ply is subsequently introduced between the two sheets and the bent glass sheets are joined to one another ultimately to give a laminated glass sheet (in the context of the present disclosure also referred to simply as “laminate”).

Glass sheets comprised in such a laminate are therefore subject to a series of requirements. Since the bending processes are thermal, the glass sheets and the coating applied thereto must withstand these temperatures. The glass sheets and the coating must be able to form a bond with the polymeric ply of such a kind that a stable laminate is formed and that delamination between glass and polymer does not occur. Ultimately it is necessary for the coating to have an optical density sufficient to ensure that components arranged in the border region of the windscreen are not disruptively visible. This prevents the driver of the vehicle being distracted and so increases driving safety. Microcracks or other defects in the coating are also to be avoided or at least minimized wherever possible.

Also important, however, as well as the temperature resistance of glass and coating, the abovementioned compatibility of glass/coating with a polymeric material to form a laminate, the optical density and the minimization of possible defects, is the mechanical strength, illustratively characterized by the breaking strength, of a coated glass sheet. It is known here that coatings, and especially coatings having particularly good adhesion, can impair the strength of a glass sheet. Especially coatings having particularly good adhesion, such as glass-based coatings, can critically reduce here the mechanical strength, such as breaking strength or flexural strength. This applies in principle to all glass substrates but especially so when the substrate, i.e. the glass sheet in this instance, has a low coefficient of expansion, as is the case with borosilicate glass sheets. This is because the use of known ceramic colors, for example, can result in differences in the coefficients of expansion of coating and substrate which are considered causative for the observed losses in strength of coated glass sheets.

Likewise already known for a long time are coatings referred to as sol-gel coatings or sol-gel layers on glass.

Whereas the initial commercial applications involved such sol-gel layers in the form of thin oxidic layers, being used in particular for producing optically active coating systems on glass (in the commercially available products Amiran®, Conturan® and Mirogard®, for example), it also became increasingly apparent that sol-gel materials had potential as binders in particle-based or particulate coatings.

For example, German utility model DE 20 2008 003 804 U1 describes sol-gel coatings for glass laminates. The coating may take the form, for example, of an individual porous, sol-gel-based layer, or the coating may be constructed as a multi-layer system of layers having different refractive indices. The coatings according to DE 20 2008 003 804 U1 do not comprise pigments and serve explicitly to improve the flow of light through the composite system and particularly in the form of the individual layer, may be construed as an anti-reflection layer. In so far as the glass laminate according to DE 20 2008 003 804 U1 is a two-sheet laminate, moreover, the sol-gel layers are also disposed on the side of the sheet which faces outwards, i.e. away from the other sheet in the laminate.

US 2013/0266781 A1 describes a coating construction of pigmented coatings which are obtained with a sol-gel-based binder. The coatings construction comprises two coatings, of which one coating, which in general imparts color and is disposed directly on the substrate, is a pigmented coating having a sol-gel-based binder. This at least one coating is porous with respect to the passage of fluids, and so a further pigmented coating with a silicone binder is applied as a sealing layer to the at least one coating. The result, therefore, is a glass or glass-ceramic article provided with a decorative coating system, for use as a cooking surface, for example. A laminate of multiple sheets is not addressed.

US 2009/0233082 A2 describes glass or glass-ceramic articles having a decorative coating. The decorative coating comprises at least one decorative pigment and comprises a sol-gel binder, with the decorative coating after curing and firing the coating acquiring a ceramic-like structure. Accordingly, the coating also comprises a high fraction of pigment, in particular significantly more pigment than binder, based on the weight. A laminate is not described.

French patent application FR 3 084 355 A1 describes an enameled substrate in which the enamel layer is porous. Further to the porous enamel layer, the substrate may also have another layer, for example a porous, silicon-based sol-gel coating, which is configured as a transparent functional layer and hence does not comprise pigments.

US 2015/0225285 A2 describes a method for printing on glass. With this method, a glass substrate is first coated with an adhesion promoter, after which one or even two or more layers are printed using an ink. After this printing, the coating or the coatings may be cured. It is additionally possible to apply further layers to these coatings, including, for example, to laminate a film. A laminated sheet comprising two glass sheets is not described, and nor is a pigmented, sol-gel-based coating.

US 2010/0047556 A2 describes a decorative coating for glass or glass-ceramic articles. The decorative coating comprises not only lamellar pigments but also a solid lubricant, with the weight ratio of pigment to lubricant being situated between 10:1 and 1:1. The applications concerned by the articles are those in particular of what are called cooktops. Laminated glass sheets are not addressed.

US 2010/0028629 A2 also describes glass or glass-ceramic articles which have a decorative coating. The coating comprises two coating layers, of which the layer removed from the substrate, also referred to as the seal, comprises not only lamellar pigments but also a solid lubricant, with the weight ratio of pigment to lubricant being situated between 10:1 and 1:1. The applications concerned by the articles are those in particular of what are called cooktops. Laminated glass sheets are not addressed.

Lastly, European patent application EP 3 830 046 A1 describes an enameled substrate where the enamel layer is porous. Further to the porous enamel layer, the substrate may also have other layers, an example being a porous, silicon-based sol-gel coating, which is configured as a transparent functional layer and hence does not comprise pigments. The sol-gel layer may be configured more particularly as a porous coating with anti-reflection effect that has a low refractive index of 1.3 or less.

The sol-gel layers described above either are not conceived for use in a laminate, particularly not for arrangement as an interlayer in a laminate, or are not pigmented. Nor is there any addressing of laminated sheets featuring high strength.

There is therefore a need for coated glass sheets which at least alleviate the above-stated weaknesses of the prior art. There is also a need for a paste for producing such glass sheets, and for a sheet laminate which comprises a coated glass sheet of this kind.

### SUMMARY OF THE INVENTION

Exemplary embodiments disclosed herein provide a glass sheet, more particularly a regionally coated glass sheet for a vehicle, a paste for producing such a glass sheet, and a laminate comprising such a glass sheet, which at least partly overcome or at least lessen the aforesaid weaknesses of the prior art.

In some embodiments disclosed herein, a glass sheet includes a glass including SiO₂ and B₂O₃ and at least one coating applied in at least one region of at least one side of the glass sheet. The at least one coating includes at least one binder including SiO₂ and at least one pigment. The at least one coating includes less than 500 ppm of Bi₂O₃ and/or less than 500 ppm of ZnO and/or less than 500 ppm of B₂O₃ and/or less than 500 ppm of an alkali metal oxide, based in each case on weight.

In some embodiments disclosed herein, a paste for producing a coating on a glass sheet includes: at least one binder including SiO₂, the at least one binder including less than 500 ppm of Bi₂O₃ and/or less than 500 ppm of ZnO and/or less than 500 ppm of B₂O₃ and/or less than 500 ppm of an alkali metal oxide, based in each case on weight; at least one pigment; and at least one medium.

In some embodiments disclosed herein, a laminate includes a glass sheet and a further glass sheet. The glass sheet includes a glass including SiO₂ and B₂O₃ and at least one coating applied in at least one region of at least one side of the glass sheet. The at least one coating includes at least one binder including SiO₂ and at least one pigment. The at least one coating includes less than 500 ppm of Bi₂O₃ and/or less than 500 ppm of ZnO and/or less than 500 ppm of B₂O₃ and/or less than 500 ppm of an alkali metal oxide, based in each case on weight.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation, not true to scale, of a laminate or a laminated glass sheet provided according to some embodiments of the present disclosure;

FIG. 2 shows a side schematic depiction, not true to scale, of a laminate or laminated glass sheet provided according to some embodiments of the present disclosure;

FIG. 3 shows a schematic depiction, not true to scale, of an elevation view of a sheet provided according to some embodiments of the present disclosure;

FIG. 4 is a scanning electron micrograph of a sheet provided according to some embodiments of the present disclosure; and

FIG. 5 is a chart illustrating the flexural strength of various borosilicate glass sheets which have different coatings or—as a reference—are unprinted.

Corresponding reference characters indicate corresponding parts throughout the several views. The exemplifications set out herein illustrate embodiments of the invention and such exemplifications are not to be construed as limiting the scope of the invention in any manner.

### DETAILED DESCRIPTION OF THE INVENTION

The disclosure relates generally to a glass sheet, more particularly a regionally coated glass sheet, such as a regionally coated glass sheet for a vehicle. The glass sheet generally comprises a glass comprising SiO₂ and B₂O₃, thus taking the form of a borosilicate glass sheet, and also comprises at least one coating applied in at least one region of at least one side of the glass sheet. The at least one coating comprises at least one binder comprising SiO₂ and at least one pigment and also, optionally, at least one additive in the form of a filler. The at least one coating comprises less than 500 ppm of Bi₂O₃ and/or less than 500 ppm of ZnO, based in each case on the weight.

This design has a series of advantages.

Thus, optionally, the glass sheet, in the at least one region which has the applied at least one coating on the at least one side of the glass sheet, has a flexural strength of between at least 80 and at most 300 MPa, optionally at least 100 and at most 210 MPa, optionally at least 140 MPa.

This strength value is generally valid for the entire glass sheet, and hence may also be determined, for example, on a glass sheet not coated over its full area. It has become apparent, however, that for glass sheets according to embodiments which have a coating as described according to the present disclosure, this very good strength is in fact also obtained in the coated region.

This very good flexural strength of the coated glass sheet comprising a glass comprising SiO₂ and B₂O₃, thus in other words of the coated borosilicate glass sheet, is an advantageous result of the design of the at least one coating, which comprises a binder which comprises SiO₂ but at the same time less than 500 ppm of Bi₂O₃ and/or less than 500 ppm of ZnO, here as well based in each case on the weight, and/or less than 500 ppm of B₂O₃ and/or less than 500 ppm of an alkali metal oxide, based in each case on the weight. This is because of the specific design of the coating, designed, indeed, according to some embodiments as a sol-gel coating.

In accordance with the present disclosure, therefore, it is possible to combine the advantage of a glass-based coating, that is, of a coating with an inorganic, amorphous (more particularly X-ray-amorphous) binder, with good strength of a resultant coated glass sheet, in a simple way. The good strength of the resultant coated glass sheet, manifested more particularly in the flexural strength, which is optionally within the aforesaid limits, is a consequence in particular of the fact that the present at least one coating, despite comprising SiO₂, is not in the form of a glass flux-based coating and therefore can be—and optionally also is—cured/fired at temperatures which are not too high, especially as compared with glass flux-based coatings. For example, in the case of the coatings according to embodiments, temperatures of up to 400° C. are sufficient for firing, temperatures, for example, of about 380° C. This may be especially advantageous with a view to the differences in coefficient of thermal expansion which arise between the coating and the substrate, in the present case, therefore, the glass sheet, and which may contribute to a reduction in the strength. While a glass flux-based coating likewise affords the advantage of a glass-based coating with high thermal, mechanical and/or chemical integrity, depending on the precise composition of the glass flux used, it must be fired at relatively high temperatures, entailing the melting not only of the glass flux itself but also at least incipient melting of a part of the surface of the glass substrate, with formation of what is called an “incipient-melting reaction zone”. Not only is this melting procedure more energy-intensive than the curing/firing of the at least one coating provided according to the present disclosure, but also this incipient melting of the surface of the glass sheet lowers the strength of the coated glass sheet relative to its original strength.

The low firing temperature of the coating provided according to embodiments of the disclosure may also therefore be advantageous, in comparison to the firing temperature of glass flux-based coatings, because the bending process, which, for a laminate for which a glass sheet provided according to embodiments can be used, is generally not guided by the firing temperatures of the coating but is instead frequently dependent solely on the substrate, and the T_{g}(transformation temperature of the glass, glass transition temperature) of the substrate.

It is true that there are a series of glass fluxes which address the problem of the high firing temperature and/or whose coefficient of thermal expansion is as good as tailored to more low-expansion glasses, such as borosilicate glass, for example, in particular glass fluxes based on Bi₂O₃ or ZnO. Nevertheless, even in this case there remains the inherent reduction in strength resulting from a partial incipient melting of the glass surface.

This problem can be addressed with the at least one coating provided according to the present disclosure, where the coating comprises a binder which comprises SiO₂ but which is in fact not a glass flux. According to some embodiments, the binder according to the present disclosure may be in particular a sol-gel binder, more particularly one based on SiO₂, with the resultant coating having a binder formed very predominantly, in other words to an extent of more than 50% by weight, optionally indeed more than 90% by weight, of SiO₂. The ZnO and Bi₂O₃ components which are characteristic of a glass flux are present in the at least one coating, very generally, at less than 500 ppm each, based on the weight. Nevertheless, with a coating of this kind, the advantageous properties of a glass-based coating, particularly the good thermal and chemical integrity, can be obtained, in conjunction with good mechanical strength of the coated glass sheet.

The flexural strength of the (coated) glass sheet here in the coated region is optionally at least 50% of the flexural strength of the uncoated glass sheet. The mechanical strength, such as the flexural strength, for example, is a statistical value, and so here, of course, there would not be investigation of the flexural strength before and after coating for the same sheet; instead, this statement above refers to investigations conducted on uncoated glass sheets and coated glass sheets having the same compositions and design. Flexural strength in the context of the present disclosure refers to a glass sheet strength also identified as double-ring tensile bending strength, determined in each case according to DIN 1288-5. In the context of the present disclosure, the strength value reported in each case is the arithmetic mean.

Advantageous generally is the embodiment of the binder as comprising SiO₂. In this way, generally, the binder is able to have good chemical and thermal integrity. Such binders may generally be silicones, polysiloxanes, polysilsesquioxanes or partial hydrolysates of siloxanes and mixtures thereof, or may comprise these. The stated binders are bundled together in this text in the generic term of sol-gel binders. Where these binders and/or their precursor materials (precursors) comprise organic constituents, these constituents may remain in the resulting coating after curing and possibly after thermal firing, or else may to a large extent be burned out, depending on the precise composition of the precursor materials and on the respective firing procedure.

One of the factors giving such a coating provided according to embodiments of the present disclosure good chemical integrity is that further components which are typically constituents of a glass flux-based coating for borosilicate glass sheets, and which serve to achieve a melting point as low as possible (and, accordingly, a firing temperature as low as possible), are not comprised in the at least one coating provided according to some embodiments.

Hence the at least one coating alternatively or additionally, according to the disclosure, comprises less than 500 ppm of an alkali metal oxide. An alkali metal oxide in the present disclosure refers to the oxide of an alkali metal. More particularly, the coating according to some embodiments comprises less than 500 ppm of Na₂O and/or of K₂O and/or of Li₂O. The stating of ppm is based here—generally always in the context of the present disclosure—on the weight.

Alternatively or additionally, the at least one coating according to the disclosure comprises less than 500 ppm of B₂O₃. B₂O₃ is a widely used component in glass fluxes for sheets composed of or comprising borosilicate glass, being used more particularly to contribute to a lowering of the melting temperature of the glass flux and/or to extremely low thermal expansion on the part of the resulting coating. The absence of this component therefore emphasizes the formation of the at least one coating as a coating which, while being glass-based, is indeed not glass flux-based.

According to some embodiments provided according to the disclosure, the at least one coating is formed as a sol-gel coating. A sol-gel binder, generally, refers to a binder in which at least one constituent is a constituent obtained by a hydrolysis-condensation reaction from an organosilicon precursor, for example by the acid-catalysed hydrolysis and condensation of compounds such as tetraethyl orthosilicate (TEOS) or related or similar compounds, there being great variation in the preparation of such binders and also the possibility of mixing of different precursors—for example, the addition of predominantly inorganic, particle-based sols or the addition of so-called polysiloxanes and/or silicones, which in the context of this disclosure are all subsumed within the large term of “sol-gel binder”.

The advantage of the sol-gel binders composed of or comprising SiO₂ is not only their great flexibility in constitution, but also their high compatibility with glasslike substrates such as glass and glass-ceramic with a wide variety of different compositions. For glass or glass-ceramic substrates with low coefficient of thermal expansion, in particular, a binder of this kind may be advantageous, since in this way not only is there effective attachment of a coating, such as, for example, the at least one coating of the glass sheet provided according to the disclosure, but also, as a result of SiO₂ as binder, a low coefficient of linear thermal expansion can be obtained on the part of the coating.

Consequently, it may also be particularly advantageous if the at least one coating comprises a sol-gel binder, since this ensures that relatively low firing temperatures, for example of less than 450° C. or indeed even lower, for example of 400° C. or less, are sufficient for the firing of the at least one coating.

In this way it is then also an easy possibility for the glass sheet to have very high flexural strengths, which cannot be realized, for example, with conventional, glass-based, particularly enamel layers, and in certain circumstances not with silicone-based coatings either. Also advantageous for this purpose is the combination of the at least one coating comprising a sol-gel binder with a glass sheet comprising SiO₂ and B₂O₃. The glass sheet, as observed above, comprises a so-called borosilicate glass or is, in other words, configured as a borosilicate glass sheet. This kind of glass material (or glass for short) is a chemically highly resistant material, which is also resistant mechanically and, by comparison with conventional glasses such as soda-lime glasses, exhibits good thermal integrity and already has good mechanical strength as well, even in a non-prestressed state. It has also emerged that the scratch resistance of such borosilicate glasses is greater than that of soda-lime glasses. Together with the at least one coating provided according to embodiments, the already good strength of the glass sheet may here be obtained or advantageously supported and possibly, indeed, further improved.

It is generally possible for a coating to comprise two or more binders, thus having a hybrid configuration, for example. There are coatings known, for example, which further to a sol-gel component comprise a glass flux-based component or an organic, polymer-based component. This may be necessary, for example, if certain properties cannot be achieved by one binder alone and organic components in the form of an added additional binder are needed, for example, to establish sufficient denseness of the resulting coating.

According to some embodiments provided according to the disclosure, however, this is not envisaged. Instead, according to such embodiments, it is envisaged that the at least one coating comprises only a single binder, optionally a binder in the form of a sol-gel binder.

According to some embodiments, the degree of surface coverage of the at least one side of the glass sheet with the at least one coating is at least 10% and at most 80%, optionally at least 15% and at most 65% of the total surface area of that side of the sheet on which the at least one coating is applied. According to further embodiments, however, there is generally also the possibility for full-area coverage or a degree of coverage of more than 80%, for example of 90% or 95%, with the at least one coating. This is recommended in particular for applications where the glass sheet and/or a laminate produced therefrom is used as a cover plate rather than as a viewing window.

A sheet in the context of the present disclosure refers generally to a plate-shaped body. A glass sheet (which may be coated and uncoated) is a sheet comprising or composed of glass. A shaped body is plate-shaped when its spatial dimensions in one spatial direction in a Cartesian coordinate system are at least one order of magnitude smaller than the spatial dimensions in the two other spatial directions, at right angles to the first spatial direction, in the Cartesian coordinate system. In other words, the thickness of the shaped body is at least one order of magnitude smaller than its length and width. The two main faces or main surfaces of the sheet, i.e. those whose magnitudes are determined by length and width, are also just called sides for short in the context of the present disclosure.

According to some embodiments, the visual transmittance, τᵥᵢₛ, in the at least one region of the glass sheet in which the at least one coating is disposed is at most 10%, optionally at most 7% and optionally at most 5%, optionally at most 1%. According to some embodiments, τᵥᵢₛ is at least 0.01%, optionally at least 0.05%, and optionally not more than 0.3%. These values refer here to a region in which the at least one coating covers the full area of the glass sheet.

The at least one coating may be applied comprehensively, that is, based on the region, “over the full area,” i.e. without interruption in the coating, in the at least one region on the glass sheet, or else may be disposed, for example, in the form of what is called a dot grid. Combinations of these variants are possible as well. For example, it is also possible for a full-area coating, thus without interruptions of the coating, disposed on the glass sheet to transition to a dot grid in the edge region of the coating, typically toward the middle of the glass sheet. This is, for example, a customary configuration of the at least one coating, which in this case thus has a structured disposition on the glass sheet, for glass sheets which are used in front windows of vehicles.

According to some embodiments, the glass sheet is configured such that in at least one subregion or within the entire at least one region of the at least one side of the glass sheet, a further coating is disposed on the glass sheet, optionally a glass-based coating, more particularly an enamel coating.

A configuration of this kind may be advantageous if the advantages of a sol-gel coating are to be realized with the at least one coating, but at the same time advantages of an enamel coating are also desired. Particularly for versions for which particularly good scratch resistance of the overall layer construction is necessary and/or desired, therefore, it may be advantageous to apply a further coating, an enamel coating for example, to the at least one coating embodied in particular as a sol-gel layer. In this case, the at least one coating which is applied first acts as an interlayer and decouples the enamel coating from the glass sheet, so that very good strength values are still always obtained for the glass sheet. At the same time, in the region in which the further coating covers the at least one coating applied first, the further coating acts as a capping layer and may therefore provide critical improvement in, for example, the scratch and abrasion resistance of the overall layer construction.

According to some embodiments, the at least one coating comprises between at least 15% by weight and at most 55% by weight of binder, optionally at least 20% by weight, optionally at least 25% by weight. This may be advantageous since in this way an optimal compromise is achieved between good mechanical integrity of the at least one coating and good covering effect and sufficient strength of the coated glass sheet.

According to some embodiments, the at least one coating comprises between at least 15% by weight and at most 30% by weight of pigment, based on the sum total of all pigments comprised by the at least one coating. This may be advantageous since in this way it is possible to achieve a good covering effect of the at least one coating, including in particular in a single-layer construction, i.e. a construction in which only the at least one coating is disposed at least regionally on the glass sheet.

The rest of the coating is generally formed by fillers, for example nanoparticulate fillers composed of or comprising SiO₂, but also other fillers as described in the context of the present disclosure. SiO₂-based fillers in particular, however, are difficult to detect here, not least since they combine well with the matrix of the binder, particularly with that of a sol-gel binder.

The at least one coating here may generally comprise only one pigment. A pigment in the context of the present disclosure refers generally to a chromophore, more particularly a ceramic chromophore, which provides a coating with defined coloration and/or defined optical appearance, for example what is known as “metallic” effect. The concept of the pigment in the context of the present application therefore thus includes, generally, what are called pure color pigments, more particularly so-called ceramic pigments, optionally oxidic pigments. Optionally, there may be oxidic mixed oxide pigments with spinel structure, for example. The concept of the pigment in the context of the present disclosure further also includes what are called effect pigments, based for example on mica, and also other effect pigments, especially effect pigments in which a platelet-shaped substrate composed of an oxidic material or based on mica is in a coated form. In the context of the present application, the statement that a coating, such as, for example, the at least one coating provided according to embodiments, or a paste, for example a paste provided according to embodiments, comprises a pigment means generally that they comprise a particulate chromophore, thus comprising particles, with these particles having the composition of the corresponding pigment. Where, therefore, it is said in the context of the present disclosure that a coating or a paste comprises two or more pigments, this means that the coating and/or the paste comprises pigment particles with different compositions, corresponding, indeed, to the composition of the pigments comprised by the coating/the paste.

The at least one coating may comprise only a single pigment. It is, however, possible, and may also be preferable, for the at least one coating to comprise two or more pigments. For example, it may be provided that the at least one coating comprises a white pigment and also a black pigment, in order to be able to compensate to, in a customary way, any batch-related fluctuations in the color locus of the pigments used. Optionally, the at least one coating may also comprise a further pigment, for example an effect pigment, since such effect pigments, frequently based on platelets, may have advantageous effects for the properties of a coating, such as its smoothness/surface quality, for example, and hence for its mechanical strength as well, such as scratch and abrasion resistance.

According to some embodiments, the glass of the glass sheet provided according to some embodiments hence the borosilicate glass comprised by the glass sheet, has a coefficient of linear thermal expansion of between 2*10⁻⁶/K and 6*10⁻⁶/K. The glass in this case, therefore, has a relatively low thermal expansion by comparison with conventional soda-lime glass. In this way, a configuration of the glass sheet as composed of one of the known, low-expansion borosilicate glasses is also possible. This may especially be advantageous since these borosilicate glasses already provide a rather high glass strength intrinsically. Moreover, such glasses also exhibit rather good thermal integrity and are rather resistant chemically as well.

According to some embodiments, the glass of the glass sheet comprises at least 60% by weight of SiO₂ to at most 85% by weight of SiO₂ and/or at least 7% by weight of B₂O₃ to at most 26% by weight of B₂O₃. Such glasses are readily meltable, but at the same time, in comparison to conventional soda-lime glasses, for example, they exhibit improved chemical integrity, hardness and strength. They are therefore especially readily suitable for use for areas involving particular mechanical stress, more particularly, for example, as a window in a vehicle, for example a windscreen. Such glasses may also therefore be advantageous because they offer a good compromise between good mechanical, chemical and thermal integrity on the one hand and good meltability on the other, without disruptive effects from separation tendencies and/or excessive glass melt viscosity. Glass sheets composed of such glasses, such as borosilicate glasses with a low coefficient of thermal expansion within the limits stated above and/or with the components in the aforementioned limits, for example, may be preferred according to embodiments of the disclosure.

According to some embodiments, the at least one coating has a coefficient of linear thermal expansion of between at least 3*10⁻⁶/K and at most 10*10⁻⁶/K, optionally of less than 9*10⁻⁶/K, optionally of less than 7.5*10⁻⁶/K, optionally of less than 6*10⁻⁶/K. This embodiment may be linked in particular with those versions of the glass sheet for which the coefficient of linear thermal expansion of the glass in the glass sheet is likewise limited and is between 2*10⁻⁶/K and 6*10⁻⁶/K. This, indeed, is a particularly simple way of obtaining glass sheets, comprising a pigmented coating comprising a sol-gel binder comprising SiO₂, which exhibit sufficient flexural strength. However, it is generally also possible for coatings having coefficients of linear thermal expansion within the aforementioned limits with glass sheets to be combined, which have a significantly higher, differing coefficient of linear thermal expansion, and vice versa. Here, however, different measures will then be taken to level out the difference in expansion coefficients. This may be done for example, as also already described above, by a so-called adaptation layer or interlayer as a further coating.

In so far as the present application refers to the coefficient of thermal expansion, what is meant thereby is the coefficient of linear thermal expansion α. Unless otherwise observed, this coefficient is reported in the range of 20-300° C. The designations α and α₂₀₋₃₀₀ are used synonymously in the context of this invention. This may be determined particularly for glassy materials in a method according to ISO 7991. The coefficient of thermal expansion of the coating refers in each case to the resulting coefficient of thermal expansion of the coating in question, which is a product of the coefficients of thermal expansion of the individual constituents of the coating with regard to their proportion in the coating. Where the present application references the coefficient of thermal expansion of the glass sheet, what is meant is always the coefficient of thermal expansion of the glassy material (or glass) of the glass sheet (i.e. of the substrate).

According to some embodiments, the glass sheet has a thickness of between at least 1 mm and at most 12 mm. This represents a good compromise between sufficient strength and still-low weight of the glass sheet used, particularly if the glass sheet is intended for use in a laminate with a further sheet.

According to some embodiments, the at least one coating is microporous in form and/or at most has pores having a maximum lateral dimension, for example a diameter, of 1 μm. Surprisingly it has emerged that enamel-based coatings, which enable comparable strengths of the coated glass sheet for given coverage with the at least one coating, have a distinctly different pore structure. It has become apparent, indeed, that enamel layers, which enable an at least approximately comparable strength (in general, however, this will always be lower than is the case with a coating provided according to embodiments) of the regionally coated glass sheet, have a rather high porosity with pore dimensions of more than 1 μm as maximum lateral dimension, often with maximum lateral dimensions of several micrometres. Such coatings, therefore, are then macroporous in form. Such pores may then increasingly be formed particularly at the interface between coating and glass sheet, i.e. between coating and substrate. The structure of the coating provided according to embodiments, conversely, is distinctly different and has only a few, small pores. The maximum lateral dimension of a pore refers here to its greatest extent. Generally speaking, the pores are ellipsoidal in form, often with only slight deviation from a spherical form. The maximum lateral dimension may therefore also be referred to approximately as the diameter of the pores.

According to yet further embodiments, the glass sheet, in the at least one region in which the at least one coating is disposed, for the coating thicknesses indicated above, has an optical density of at least 1 and at most 4.5, for example at most 3. The optical density or color density is used to characterize the absorption behaviour of a coating in comparison to an “absolute white.” The denser the color layer, the less light is able to pass through it. The optical density is calculated according to the following formula:

$$D = log ( \frac{1}{R} )$$

R here is the reflectance. The optical density is determined using densitometers, particularly, in the context of the present disclosure, in a perpendicular direction to the greatest superficial extent of the coating and hence of the coated surface of the coated glass sheet. The higher the optical density, the less transparent the coating appears. This may be achieved with particular advantage via a high pigment content and/or by the nature and amount of the selected pigments in the at least one coating and may be achieved particularly with pigment contents more in the upper region of the above-stated range, between 0% by weight and 30% by weight of pigment.

The present disclosure also relates to a paste. In particular, the present disclosure relates to a paste for producing a coating which is disposed as at least one coating on glass sheets provided according to embodiments, and is therefore also suitable for producing a glass sheet provided according to embodiments, which thus is disposed at least regionally on at least one side of the glass sheet. The paste comprises at least one binder comprising SiO₂, at least one pigment, at least one medium, and optionally at least one additive in the form of a filler. The binder comprising SiO₂ takes the form of a sol-gel binder, comprising at least one SiO₂ phase crosslinked by hydrolysis and condensation of at least one semi-organic silicon oxide precursor phase, where a semi-organic silicon oxide precursor phase means a silicon compound in which an organic radical, more particularly an alkyl radical, is bonded to the silicon atom directly or via an oxygen bridge atom. The paste is characterized in that the binder comprises less than 500 ppm of Bi₂O₃ and/or less than 500 ppm of ZnO. According to some embodiments, the binder may also additionally have less than 500 ppm of B₂O₃ and/or less than 500 ppm of an alkali metal oxide, where here the statements about the binder made earlier in relation to the glass sheet are also valid generally and correspondingly for the binder of the paste.

The medium may generally also be referred to as dispersion medium. As observed, a glass sheet provided according to embodiments may be obtained advantageously by such a paste.

According to some embodiments, the paste generally is configured such that the binder comprising SiO₂ is in the form of a sol-gel binder, comprising at least one SiO₂ phase crosslinked by hydrolysis and condensation of at least one semi-organic silicon oxide precursor phase, where a semi-organic silicon oxide precursor phase means a silicon compound in which an organic radical, more particularly an alkyl radical, is bonded to the silicon atom directly or via an oxygen bridge atom. This may be especially advantageous, since in this way, with regard to the composition of the binder and in spite of the restriction to substantially pure SiO₂ chemistry, meaning that optionally at least 90% by weight of the inorganic constituent of the binder is formed by SiO₂, there is great flexibility. Indeed, such semi-organic silicon oxide precursor phases can be used and crosslinked flexibly and may also be combined with further SiO₂ precursor materials, examples being precondensed and dispersed SiO₂ nanoparticles, of the kind known commercially, for example, under the trade name “Levasil,” or with other dispersions of nanoparticles, more particularly SiO₂ nanoparticles, as also further observed below. It is also possible to use precursor phases of a kind in which the silicon atom has four oxygen bridge atoms, or else of a kind in which at least one organic radical is bonded directly to the silicon atom, particular reference here being given, as observed above, to alkyl radicals. An alkyl group specifically, particularly a methyl group, which is bonded directly to the central silicon atom may be advantageous, since in this way the coating provides a certain inherent denseness and integrity with respect to water and water vapor and at the same time may be highly compatible with organic constituents of, for example, a laminate film. It is particularly significant that a methyl group in particular has particularly high temperature stability and may be optionally employed for that reason. Alternatively, a phenyl group could also be substituted, but is less temperature-stable and on decomposition may possibly also be hazardous to health. Generally it may be preferred if there are at most two organic groups per silicon atom in the precursor, in order to enable a network formation efficiently. Preference may be given to one organic group per silicon atom, as in the methyl triethoxy silicate precursor/precursor phase, for example.

The paste according to some embodiments comprises between at least 10% by weight and at most 40% by weight, optionally at least 15% by weight and at most 30% by weight, of additive, optionally a filler, based on the total weight of the paste and based on the sum total of the additives, optionally fillers, comprised in the paste.

In this way, a very advantageous compromise is achieved between the improvement in paste properties and/or properties of the resulting coating through the addition of fillers, and the establishment of a dense, very dark and color-neutral color locus on the part of the resulting coating. The reason is that too great a quantity of fillers may possibly also be disadvantageous for the covering effect of the pigments used.

As far as a filler is concerned, it is understood here that it is a particulate substance, thus comprising particles, with these particles having the composition of the corresponding filler. Accordingly, where it is said in the context of the present disclosure that a coating or a paste comprises two or more fillers, this means that the coating and/or the paste comprises filler particles of different compositions, specifically corresponding to the composition of the fillers comprised in the coating/the paste.

According to some embodiments, the paste comprises a filler having a coefficient of linear thermal expansion of between −10*10⁻⁶/K and +10*10⁻⁶/K, in other words a filler which optionally has a relatively low coefficient of linear thermal expansion. In particular this may be a optionally fumed silica, SiO₂-based particles generally, or graphite. A relatively low coefficient of linear thermal expansion of this kind, of between −10*10⁻⁶/K and +10*10⁻⁶/K, optionally between −8*10⁻⁶/K and +5*10⁻⁶/K, optionally between −6.5*10⁻⁶/K and +3*10⁻⁶/K, may be advantageous in particular for a binder as used in the context of the at least one coating provided according to embodiments, specifically a binder comprising SiO₂. This ensures effective incorporation of the filler into the coating, with the filler able to further improve the stability of the coating—that is here, in particular, at least one coating of the glass sheet according to the present disclosure—in relation, for example, to scratch and/or abrasion resistance.

Fillers as a constituent of a paste, a sol-gel paste for example, are already long-established common knowledge. Such fillers may influence, and in particular improve, the properties of a paste comprising them, and also of the coating resulting therefrom, in a variety of ways, by being able, for example, to improve the crosslinking of a sol-gel matrix.

Another possibility is the use of fillers which serve as rheological additives in a paste, for example, but at the same time can also be integrated effectively into the coating resulting from said paste, where they have further functions, an example being the function of improving the abrasion of the coating. Particularly in the case of sol-gel pastes and a coating resulting therefrom, the use of fillers as rheological additive is known practice.

As observed, it is also possible according to some embodiments for the paste to comprise a further additive, for example a filler. In the event that the paste comprises two or three fillers, this further filler may optionally, as observed, likewise be a filler having a rather low coefficient of linear thermal expansion, for example having a coefficient of linear thermal expansion of between −10*10⁻⁶/K and +10*10⁻⁶/K, optionally between −8*10⁻⁶/K and +5*10⁻⁶/K, optionally between −6.5*10⁻⁶/K and +3*10⁻⁶/K.

As also observed above, fillers having a coefficient of thermal expansion within the aforesaid range, whether as the sole filler or else where there are two or more fillers present, may be particularly advantageous for the development of the properties of the at least one coating and correspondingly, the properties of the glass sheet as well. Moreover, fillers of these kinds, particularly in the case of silica, may provide advantageous properties for the paste itself, by also enabling or supporting the adjustment of the viscosity, for example, a viscosity which is suitable for the application by a printing method such as screen printing. Moreover, the development of the filler in the form of low-expansion filler may likewise be advantageous. It is not absolutely necessary, however, for the filler to have a very low coefficient of linear thermal expansion. As observed, the filler may indeed be graphite, which in that case has further advantages that outweigh the relatively high coefficient of thermal expansion of this material by comparison with amorphous silica, particularly if it is considered that the binder itself may have a fairly low coefficient of thermal expansion and the material of the glass sheet according to some embodiments may itself have a coefficient of linear thermal expansion in the range between 2*10⁻⁶/K and 6*10⁻⁶/K.

Generally speaking, then, as already observed above as well, fillers may fulfil very different functions in a paste and/or in the coating resulting therefrom. For the production of the at least one coating of the glass sheet provided according to embodiments of the disclosure, it has emerged that it may be particularly advantageous if the paste comprises two kinds of fillers. Of course, the resulting coating may also comprise these two fillers, especially in the case of high-temperature-stable fillers, though detection in the coating itself may in certain circumstances be difficult, according to the individual case and particularly in the case of fairly low filler contents.

According to some embodiments, for example, one filler may be a silica, more particularly a fumed silica. A configuration of this kind may be advantageous since fumed silica—that is, in other words, viewed chemically, amorphous SiO₂—not only is a known material with ready availability, but is also able to exercise advantageous properties in a paste, as a rheological additive, for example. In this way, there is no need to have to use organically modified rheological additives, for example, which may possibly be difficult to remove from the resulting coating, which in the later use of the glass sheet might possibly result in unattractive discoloration or other failure of the coating. Moreover, a fumed silica remains in the coating and, because of its effective incorporation into a sol-gel matrix based on SiO₂, as presently in the case of the glass sheets provided according to the present disclosure, may also further promote the effective wetting of the coating within the coating itself and also with respect to the substrate. Since fumed silica as amorphous SiO₂ itself has only a low coefficient of thermal expansion and, moreover, can be prepared in a multiplicity of variants, it is possible in this way to exert targeted influence over the properties of the resulting coating. A filler in the form of silica is therefore particularly advantageous according to some embodiments. Here in particular it is apparent, incidentally, that the filler is also present in the resulting coating, yet in the case of a coating matrix formed very predominantly of SiO₂, it is no longer detectable as such. The influence of the filler, however, is manifested in the resulting advantageous properties of the coating thus obtained.

Another category of fillers, particularly in the area of pigmented sol-gel coatings, are those known as “lubricants.” A “lubricant” in the sense of the present disclosure refers to a solid which has a “lubricating” effect analogous to the effect of talc. The genesis of this effect is that the relevant filler in lubricant form itself possesses a platelet-shaped structure. Known fillers which may be advantageous and used in sol-gel coatings are graphite or boron nitride, for example. According to some embodiments, the paste comprises optionally graphite as filler. This filler as well has sufficient temperature stability, and so is also comprised in the resulting coating. However, it is not readily detectable, owing in particular to the low atomic number of carbon, and for this reason it cannot be easily visualized in an EDX analysis, for example.

The advantageous effect of a lubricant such as graphite or boron nitride, which is manifested particularly in the resultant good properties of the coating, is not fully understood by the inventors. It has nevertheless emerged that those fillers with platelet-shaped structure, in particular with a graphite-like construction based on the crystal structure of the fillers in question, may be advantageous for the development of particularly stable sol-gel-based coatings.

Such lubricants, however, also have certain disadvantages. It has been known to date that such fillers, particularly in the context of a sol-gel coating, are able to bring about the desired properties particularly when there is a certain ratio in the paste (and, correspondingly, in the resulting coating as well) between pigment used and the lubricant, of between 10:1 and 1:1, based on the weight.

In the case of graphite as filler, it may well provide some positive properties of the resulting sol-gel coatings, but also leads to certain unwanted properties. Since graphite itself has a coloration, only relatively dark colors are possible for the corresponding coatings in this way, and yet it is difficult again to achieve a truly dark, black coloration with such relatively high levels of graphite. Since the pigments used according to the prior art were usually also effect pigments, the color palette with graphite as lubricant has to date been very limited, involving mostly pastes from which coatings light to dark grey with a “metallic” effect were produced. Moreover, in the case of a very high fraction of graphite, advantageous on the one hand for the development of advantageous mechanical properties of the layer, such as good adhesive strength, scratch resistance and abrasion resistance, and also good denseness, the layer was also usually conductive, which for certain applications was unwanted.

An example of a possible alternative to the use of graphite as lubricant may involve using boron nitride, which may also be referred to as “white graphite.” However, it is associated with the formation of a rather white or light-colored layer, which may be unfavorable for masking coatings, for the frames of glass sheets intended for use as car window in a window laminate, for example. Moreover, boron nitride is expensive to produce and therefore unfavorable for reasons of energy efficiency and cost.

Lastly it should also be pointed out that it may be difficult to wet a coating of this kind provided with lubricant. On the one hand this may be favorable for certain applications, yet it is feared that too high a fraction of such fillers in the form of lubricants, as stated in the existing prior art, may be unfavorable, particularly in respect of later lamination of a glass sheet provided with a coating comprising lubricants. Accordingly, then, there is particular demand for pastes for producing coatings for glass sheets that are used, for example, in a laminate and for which dark colors as well, more particularly a dark black, are to be attained.

Surprisingly it has emerged that according to some embodiments, significantly lower amounts of a lubricant than known to date may already be sufficient in a paste and, correspondingly, in a resulting at least one coating of a glass sheet provided according to embodiments. Where the filler is present as a lubricant, the ratio of pigment to lubricant according to some embodiments is more than 20:1, optionally more than 30:1 and optionally more than 40:1, based on the total weight of the sum total of the pigments and the sum total of the fillers in the form of lubricant that are comprised in the paste and in the resulting coating, respectively, based in each case on the weight fraction of the respective constituents. This results not only in a greater freedom of design, in the provision of particular colors, for example, for a resulting coating. Instead, in this way, surprisingly, advantageous mechanical properties and a still-sufficient scratch resistance are made possible for a coating produced accordingly, such as the at least one coating on a glass sheet provided according to embodiments of the disclosure, while at the same time it is possible to avoid disadvantages of known layers of the prior art. In particular, the glass sheets obtained in this way comprising at least one coating are highly suitable for forming a firm laminate in a lamination process with a further glass sheet, the laminate satisfying the requirements for the window of a vehicle, for example.

According to some embodiments, the paste comprises up to 50% by weight of a solvent, optionally a high-boiling solvent having a boiling point of at least 130° C. and optionally at most 330° C., for example at most 220° C.

More particularly, the solvent may be or may comprise diethylene glycol monoethyl ether. Such a configuration is particularly favorable for printing inks, since in this way a paste is formed which is printable well by screen printing, for example, and for which there is no drying of the paste on the screen.

According to yet further embodiments, the paste comprises a solution of a cellulose, for example an ethylcellulose, optionally in an amount of between 5% by weight and 10% by weight, based on the total weight of the paste. The cellulose may be in solution, for example, in a high-boiling solvent, for example diethylene glycol monoethyl ether.

A paste configuration of this kind is not stated in the cited texts of the prior art. Hitherto, indeed, the assumption was that a cellulose advantageous, for example, for establishing a paste viscosity particularly advantageous for screen printing cannot be used effectively in sol-gel-based pastes. The reason for this is that, typically, semi-organic SiO₂ compounds are usually subjected to incipient acidic condensation, meaning that the pH of such a paste is relatively low, more particularly below 7, and is therefore in the acidic range. Cellulose, however, undergoes decomposition in such acidic solutions, and so only pastes with a pot life of a few days could be obtained in this way.

As already observed above for the at least one coating the configuration of the binder as an SiO₂-comprising sol-gel binder may generally be advantageous. As observed, SiO₂-comprising binders may be obtained, for example, by a hydrolysis-condensation reaction from organosilicon precursors or precursor compounds, for example by the acid-catalysed hydrolysis and condensation of compounds such as tetraethyl orthosilicate (TEOS) or related or similar compounds, there being great variation in the preparation of such binders and also the possibility of mixing of different precursors—for example, the addition of predominantly inorganic, particle-based sols or the addition of so-called polysiloxanes and/or silicones, which in the context of this disclosure are all subsumed within the large term of “sol-gel binder”.

The advantage of the sol-gel binders composed of or comprising SiO₂ is not only their great flexibility in constitution, but also their high compatibility with glasslike substrates such as glass and glass-ceramic with a wide variety of different compositions. For glass or glass-ceramic substrates with low coefficient of thermal expansion, in particular, a binder of this kind may be advantageous, since in this way not only is there effective attachment of a coating, such as, for example, the at least one coating of the glass sheet provided according to the disclosure, but also, as a result of SiO₂ as binder, a low coefficient of linear thermal expansion can be obtained on the part of the coating.

Pastes by which sol-gel-based coatings may be obtained are described for example in US 2010/0028629 A2. US 2010/0047556 A2 as well cites sol-gel pastes of similar construction. Lastly, also, US 2009/0233082 A2 describes pastes with which sol-gel-based coatings may be obtained.

Nevertheless, the coatings stated in the above patent applications are not suitable for producing a glass sheet provided according to embodiments. The pastes described therein are conceived instead for the production of coatings on a usually glass-ceramic substrate with a very low expansion, optionally a substrate having a coefficient of linear thermal expansion of less than 2*10⁻⁶/K, specifically LAS glass-ceramics of low thermal expansion of the kind used, for example, for hobs, among other uses. As a result of the particular difficulties arising in the coating of a substrate of this kind with low expansion, the pastes and, correspondingly, the resultant coatings have different compositions and a different structure than what is suitable for a glass sheet provided according to embodiments which is also to be suitable for use as a glass sheet in a laminate of a vehicle glazing system.

In particular, the layer systems given in the above texts of the prior art usually comprise two layers, which are applied in separate coating processes, and exhibit distinct differences in particular with regard to the proportion of individual components of the paste and—correspondingly—of the resulting coating.

According to some embodiments, the paste comprises between at least 15% by weight and at most 30% by weight of pigment, based on the total weight of the paste and based on the sum total of the pigments comprised in the paste. The paste optionally comprises at least 20% by weight of pigment.

In other words, the pigment content of the paste and, correspondingly, of the at least one coating as well that may be obtained by the paste provided according to embodiments is significantly different from that of the known pastes. The different composition of paste and, correspondingly, of the at least one coating also leads, in a corresponding way, to a different construction of the coating. It is presently also possible according to embodiments, therefore, for the glass sheet provided according to embodiments also to have only one single coating—for the at least one coating, therefore, to be the sole coating.

According to some embodiments, the paste comprises between at least 8% by weight and at most 20% by weight of binder, based on the total weight of the paste. The composition of the paste is optionally such that between 8% by weight to 20% by weight of the SiO₂ content of the paste, based on the total weight of the paste, results from an organosilicon precursor.

In this way, sufficient adhesive strength of the at least one coating, produced by the paste, and the glass sheet can be ensured. It is also possible in this way to achieve sufficient scratch resistance. In spite of this fairly high binder content as compared with known pastes or with coatings resulting from such known pastes, the strength of the glass sheet provided according to embodiments is not lowered below a critical level. The reason for this is that the particularly strongly crosslinking constituent, namely the SiO₂ scaffold with polymer-like crosslinking that results from the silicon-organic precursor phase, is combined with nanoparticles. Hence it is possible to achieve particularly high strengths of the resulting coated glass sheet provided according to embodiments of the disclosure.

According to some embodiments, the paste comprises at least 10% by weight and at most 40% by weight of additive, optionally a filler, based on the total weight of the paste and based on the sum total of the additives, optionally fillers, that are comprised in the paste.

The amount of additives, especially fillers, in the paste is therefore comparatively high, not only in the paste but also based on the total amount of the pigments comprised in the paste—and, correspondingly, in the at least one coating. According to some embodiments, at least one filler takes the form of a lubricant, more particularly graphite, and the ratio of pigment to lubricant is more than 20:1, optionally more than 30:1 and optionally more than 40:1. The ratio of the sum total of the pigments comprised in the paste to the sum total of the fillers comprised in the paste and taking the form of lubricants here corresponds, according to this embodiment, to the ratio which is also established in the at least one coating according to some embodiments.

According to yet a further embodiment, the paste comprises up to 50% by weight of a solvent, optionally a high-boiling solvent having a boiling point of at least 150° C. and optionally at most 330° C. More particularly, the solvent may be or may comprise diethylene glycol monoethyl ether. Such a configuration is particularly favorable for printing inks, since in this way a paste is formed which is printable well by screen printing, for example, and for which there is no drying of the paste on the screen.

According to yet a further embodiment, the paste comprises cellulose, for example ethylcellulose, optionally in an amount of between 0.1% by weight and 1% by weight, based on the total weight of the paste. The cellulose may be in solution, for example, in a high-boiling solvent, for example diethylene glycol monoethyl ether.

A paste configuration of this kind is not stated in the cited texts of the prior art. Hitherto, indeed, the assumption was that a cellulose advantageous, for example, for establishing a paste viscosity, particularly advantageous for screen printing, cannot be used effectively in sol-gel-based pastes. The reason for this is that, typically, semi-organic SiO₂ compounds are usually subjected to incipient acidic condensation. Indeed, a pH cannot be determined in the paste, since the paste comprises numerous organic solvents and the concept of a pH is not applicable for such solutions. In known pastes of the prior art, however, it was found that cellulose underwent decomposition and in this way only pastes with a pot life of a few days could be obtained. Surprisingly, though, it emerged that in the present pastes provided according to the disclosure, cellulose can be used. The reason for this is not entirely clear to the inventors. It possibly rests on the dissolving of the cellulose in a suitable solvent, namely an ether, such as diethylene glycol monoethyl ether, for example, and on the overall relatively low weight fraction of the cellulose, of at most 1% by weight.

The use of cellulose here may be advantageous since in this way the viscosity parameters of the paste can be adjusted and a better printed image produced than with the viscosity parameters of pastes without cellulose. In simplified terms, cellulose-containing pastes have a rather “honey-like” viscosity behaviour, whereas pastes made viscous exclusively using silicas exhibit a very strong thixotropy, which in a screen printing process, for example, can result in an unfavorable, excessively “pixelated,” non-levelling printed image. This can be countered by reducing the silica in the paste, although in that case the viscosity overall may be too low and the ink may “drip” through the screen. The stated disadvantages, however, can be lessened in a surprisingly simple way through the addition of cellulose within the above-stated limits.

The present disclosure also relates to a laminate. The laminate comprises a glass sheet provided according to embodiments and also a further glass sheet, with the at least one coating being optionally disposed between the two glass sheets of the laminate. In particular, between the two glass sheets of the laminate, there may additionally, in a customary way, be a polymeric ply disposed, more particularly in the form of a film, so as to form a laminated glass which may be used, for example, as a windscreen or other vehicle glazing.

### Examples

The invention is elucidated further below with reference to examples. In the table below, the compositions of pastes provided according to embodiments of the disclosure are compiled, which can be used to obtain coatings provided according to embodiments and, correspondingly, glass sheets provided according to embodiments.

Compiled in Table 1 below is an illustrative composition of an SiO₂-based sol as a constituent of the binder of the paste and—correspondingly—of the coating provided according to embodiments. The part of the paste binder in question here, as evident from the data in Table 1, is the part which comprises a semi-organic silicon compound or is formed from such a compound by hydrolysis and condensation.

TABLE 1

| Input mass [g] | Compound name | Amount | Unit | Molar mass | |
|---|---|---|---|---|---|
| 104.16 | TEOS | 0.5 | mol | 208.32 | g/mol |
| | Tetraethoxysilane | | | | |
| 178.3 | MTEOS | 1 | mol | 178.3 | g/mol |
| | Methyltriethoxysilane | | | | |
| 1.78 | p-TSH | 0.01 | mol | 190.22 | g/mol |
| | para-Toluenesulfonic acid | | | | |
| 9.011 | H₂O | 0.5 | mol | 18.022 | g/mol |
| | Water | | | | |

As is apparent from Table 2 below, it is possible to add further constituents to the binder, i.e. to the “semi-organic Si compound” or, more correctly, to the binder produced from it, as described illustratively above, in addition to this constituent obtained from hydrolysis and condensation and composed of at least one semi-organic silicon-organic precursor phase. The binder obtained overall accordingly is understood in the context of the present disclosure as a sol-gel binder. Together with further components, such as pigments and/or fillers, the paste is then obtained, with illustrative compositions being set out in the table below.

TABLE 2

| | Paste No. | | | | | | |
|---|---|---|---|---|---|---|---|
| | 1 | 2 | 3 | 4 | 5 | 6 | 7 |
| Component | [g] | [g] | [g] | [g] | [g] | [g] | [g] |
| Silicone binder | | | | 6.00 | | | |
| Semi-organic Si compound | 15.00 | 15.00 | 15.00 | 15.00 | 15.00 | 15.00 | 15.00 |
| Nanoparticle dispersion (37%) in | 60.00 | 60.00 | 60.00 | 60.00 | 60.00 | 60.00 | 60.00 |
| diethylene glycol monoethyl | | | | | | | |
| ether | | | | | | | |
| Diethylene glycol monoethyl | 9.73 | 9.73 | | | | | |
| ether (DEGMEE) | | | | | | | |
| Black pigment (Cr—Cu spinel) | 3.00 | 0.00 | 3.00 | 3.00 | 10.00 | 3.00 | 3.00 |
| White pigment (rutile) | 0.00 | 2.92 | 0.00 | 0.00 | 0.00 | 0.00 | 0.00 |
| Effect pigment | 22.00 | 22.00 | 22.00 | 22.00 | 15.00 | 10.00 | 10.00 |
| Graphite | 0.68 | 0.68 | 0.68 | 0.68 | 0.68 | 0.68 | 0.68 |
| Carbon black (lamp black) | | | | | | 14.00 | |
| Carbon black (Printex 95 type) | | | | | | | 14.00 |
| Silica | 2.25 | 2.25 | 2.25 | 2.25 | 2.25 | 2.25 | 2.25 |
| Cellulose in DEGMEE | | | 10.00 | 10.00 | 10.00 | 10.00 | 10.00 |
| Defoamer | 0.20 | 0.20 | 0.20 | 0.20 | 0.20 | 0.20 | 0.20 |

The nanoparticle dispersion is a dispersion of nanoparticles, here meaning SiO₂ particles, which have an average particle size, based on the equivalent diameter in relation to the volume, of less than 1 μm, in diethylene glycol monoethyl ether, with the fraction of the nanoparticles in the dispersion here being 37% by weight, based on the weight of the dispersion. It is of course also possible to add nanoparticles in another form, for example in the form of an aqueous sol of the kind available, for example, under the trade name “Levasil.” However, such as sol would have the disadvantage of a certain content of alkali metal oxide, particularly Na₂O, and a configuration of this kind may therefore not be preferred. The paste is optionally configured, therefore, such that it comprises a dispersion of SiO₂ nanoparticles in an organic solvent, optionally a high-boiling solvent, optionally having a boiling point of at least 130° C. and optionally at most 330° C.

Carbon blacks may likewise be added to the paste, where they act as pigment. A possibility according to some embodiments is the use of lamp blacks, for example with the CAS No. 1333-86-4. In spite of having nominally the same chemical composition to graphite, being composed of carbon, they are viewed as a pigment on the basis of their exact production and the resultant different particle morphology, and of the reduced or even absent crystallinity by comparison with graphite and the associated different particle morphology, and do not act as a lubricant in the sense of the present disclosure. The addition of carbon black may be advantageous since it allows a particularly dense layer conveying a particularly black color to be obtained. Depending on the exact type of carbon black, the properties of the paste and also of the resulting coating may differ greatly; for example, it has been found that the above-described paste 7, comprising a carbon black of the “Printex 95” type, does not emerge readily from the screen and hence does not have good printability.

With the paste provided according to embodiments, which are listed in the above table as numbers 1 to 5, coatings were applied to a glass sheet by screen printing respectively using a fine screen (140 mesh fabric) and using a coarser screen (77 mesh fabric). The pastes comprising carbon black were printed using a screen having a 77 mesh fabric.

These printed sheets are treated thermally, i.e. dried and fired, at 380° C. for one hour.

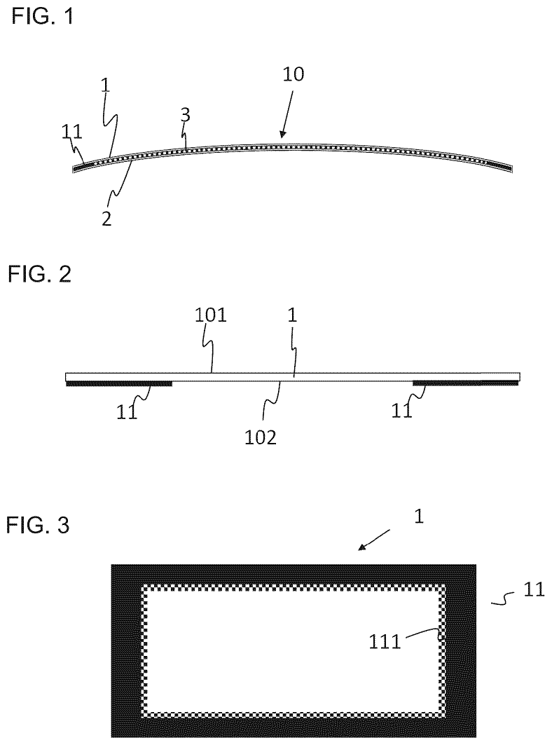

Referring now to the drawings, FIG. 1 is a schematic representation, not true to scale, of a laminate or a laminated glass sheet 10 according to some embodiments of the present disclosure. The laminate 10 comprises two sheets 1, 2, with the sheet 1 being a glass sheet for a vehicle provided according to some embodiments of the present disclosure. Sheet 2 is a further glass sheet and may consist, for example, of a soda-lime glass or else of the presently disclosed glass of the sheet 1. Disposed between the two glass sheets 1, 2 is a polymeric ply 3, and, here in the edge region of the laminate 10, the coating 11. It is disposed on one side (not designated) of the glass sheet 1 and in the context of the description below may comprise, respectively, the at least one coating alone or together with the further coating as an interlayer.

For reasons of better representation, the coating 11 here has been given a thick representation, having been represented in terms of thickness comparatively with the thicknesses of the two sheets 1, 2; however, as stated, this is solely for the purpose of better representation. In general, the coating 11 is significantly thinner than each of the two sheets 1, 2, and in general is also thinner than the polymeric ply 3. The polymeric ply 3 may also be a film.

The laminate 10 here, as can be seen, is in the form of a bent laminated glass sheet, as may also be used, for example, as a windscreen. Generally speaking, without restriction to the example represented in FIG. 1, however, it is also possible for the laminate 10 not to comprise bent sheets 1, 2, but instead to be flat in form. It is also possible for the curvature of the laminate 10 to be exactly opposite to the depiction represented in FIG. 1. In the example in FIG. 1, the glass sheet 1 would be the outside of a windscreen, but it is generally also possible for the glass sheet 1 to be disposed on the inside of a windscreen. In any case, however, the coating 3 is disposed between the two glass sheets 1, 2.

An arrangement as in FIG. 1, however, may be advantageous, since the glass sheet 1 comprises SiO₂ and B₂O₃ as components of the glassy material. Such a borosilicate glass is more scratch resistant than, for example, a soda-lime glass, and so it may be advantageous if the glass sheet 1 is designed in the laminate 10, as represented in FIG. 1, such that it faces “outwards”, i.e. would face outwards if used as a windscreen. In this way, indeed, there would be better protection against stone chipping and similar mechanical exposures.

To illustrate the construction of the glass sheet 1 according to embodiments, it is represented in FIGS. 2 and 3 in each case in the form of a schematic depiction which is not true to scale. FIG. 2 here shows a side view. Here, however, the glass sheet 1 is not in a bent form. Generally speaking, without restriction to the example shown in FIG. 1 for a glass sheet 1, it is also possible for the glass sheet to be bent. It may be advantageous, however, if initially a flat, unbent sheet 1 is used, which is then bent later on, specifically in a thermal process, for example. Here again, for reasons of better representation, the thickness of the coating 11 is represented significantly greater than in reality.

The arrangement of the sheet 1 corresponds to that in FIG. 1, as observed with the exception that the sheet in FIG. 2 is not bent. As can be seen, the coating 11 here is formed on the side 102, which in the laminate 10 faces the second sheet 2. Not depicted here is the polymeric ply 3, which in the laminate is disposed between the sheet 1 and the sheet 2. It is expressly pointed out here that the polymeric ply 3 not only directly contacts the side 102 of the sheet but is also disposed on the coating 11 that is disposed in the region (or the regions) of the sheet 1 (or of the side 102 of the sheet 1).

The coating 11 is disposed here in the edge region of the sheet 1, on the left and right respectively in the representation in FIG. 2. Here it may be the case, for example, that the coating overall is applied in the form of a “border.”

In this regard, reference is made to FIG. 3, which in a likewise schematic depiction not true to scale shows an elevation view of a sheet 1 provided according to some embodiments. The coating 11 here is in the form of a border running round the edge of the sheet 1, with the coating initially being coherent, thus in the form of a layer without interruptions, and transitioning, towards the middle of the sheet 1, through a grid or dot pattern 111 into the uncoated region. This uncoated region is the viewing region of a windscreen, for example, if the sheet 1 is used in a laminate 10. Of course, it is generally possible for the border not to be formed uniformly as represented schematically in FIG. 3, but instead, for example, to have protrusions, as is frequently the case for the windscreens, for example, in the region of the rearview mirrors.

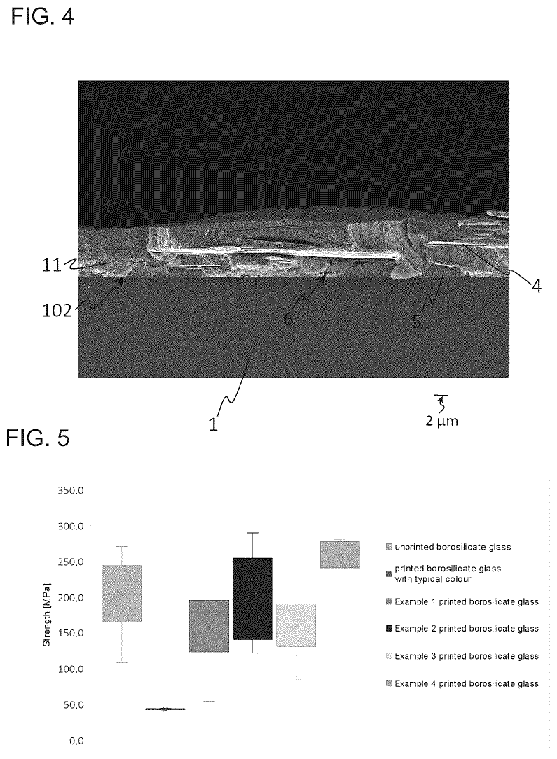

FIG. 4 is a scanning electron micrograph of a sheet 1 according to some embodiments of the disclosure, provided with a coating 11, disposed on the side 102 of the sheet 1. The coating comprises pigments, with only one illustrative pigment 4 being designated presently, and being a platelet-shaped pigment, i.e. what is called an effect pigment. As can be discerned from the representation in FIG. 4, the coating matrix 5, which may also be denoted as binder 5, has a rather fine-grained form. It comprises SiO₂ or is formed of SiO₂, and the coating comprises less than 500 ppm of Bi₂O₃ and/or less than 500 ppm of ZnO and/or less than 500 ppm of B₂O₃ and/or less than 500 ppm of an alkali metal oxide, based in each case on the weight. In particular, the binder 5 also comprises SiO₂ and less than 500 ppm of Bi₂O₃ and/or less than 500 ppm of ZnO and/or less than 500 ppm of B₂O₃ and/or less than 500 ppm of an alkali metal oxide, based in each case on the weight. The binder here takes the form of a sol-gel binder.

The coating 11 and/or the binder 5 may also comprise pores 6. These pores, however, are relatively small in form and so the coating 11 in particular is or may be microporous and/or has, at most, pores with a maximum lateral dimension, for example a diameter, of 1 μm. These pores, as is also evident from FIG. 4, are disposed optionally at the interface between the sheet 1 and the coating 11, in other words on or close to the side 102 of the sheet 1. The scale of the representation is placed beneath the scanning electron microscopic representation in the lower right-hand region of FIG. 4 and indicates the length of 2 μm.

The coating 11 here also comprises at least one additive, optionally in the form of a filler. However, this additive is not visible in the scanning electron microscopic representation. In the at least one region which here is disposed on the side 102 of the glass sheet 1 and in which the coating 11 is applied, the glass sheet 1 optionally has a flexural strength of between at least 80 and at most 300 MPa, optionally at least 100 and at most 210 MPa, optionally at least 140 MPa.

Represented in FIG. 5 is the flexural strength of various borosilicate glass sheets which have different coatings or—as a reference—are unprinted. In terms of the strength results, the unprinted borosilicate glass is represented on the far left in FIG. 5 and in this so-called “box plot” shows the strength obtained for such unprinted glass sheets. Strengths here are situated on average at somewhat above 200 MPa. Conversely, for glass sheets provided with conventional, glass flux-based coatings, there is a drop in strength, as on the basis of the values for the samples which are plotted as second from left in FIG. 5. Here, strength values of below 50 MPa are obtained. The strength therefore drops considerably as a result of such conventional coatings.

The situation is different for coatings 11 provided according to embodiments which are represented as “Examples 1 to 4” in FIG. 5. While it is also possible here for there to be a reduction in strength relative to the unprinted glass sheet (Examples 1 and 3), the values obtained in this case as well are nevertheless still more than 140 MPa, and here indeed above 150 MPa (on average). Example 2 exhibits strength values which are compatible with those of the unprinted sheets, but exhibit somewhat greater fluctuation than these. Lastly, indeed, coatings provided according to embodiments are possible, as in Example 4, for which the strength is improved by the coating, relative to unprinted glass sheets; see Example 4.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

List of reference numerals

| | |
|---|---|
| 1, 2 | Glass sheet |
| 3 | Polymeric ply |
| 10 | Laminate, laminated glass sheet |
| 11 | Coating |
| 102 | Side of the sheet 1 |
| 111 | Grid or dot pattern |
| 4 | Pigment |
| 5 | Binder |
| 6 | Pores |

What is claimed is:

1. A glass sheet, comprising:
a glass comprising SiO₂ and B₂O₃; and
at least one coating applied in at least one region of at least one side of the glass sheet,
the at least one coating comprising at least one binder comprising SiO₂ and at least one pigment, the at least one coating comprises less than 500 ppm of Bi₂O₃ and/or less than 500 ppm of ZnO and/or less than 500 ppm of B₂O₃ and/or less than 500 ppm of an alkali metal oxide, based in each case on weight.

2. The glass sheet of claim 1, wherein the at least one coating comprises at least one additive in the form of a filler.

3. The glass sheet of claim 1, wherein the glass sheet, in the at least one region which has the applied at least one coating on the at least one side of the glass sheet, has a flexural strength of between at least 80 MPa and at most 300 MPa.

4. The glass sheet of claim 1, wherein the at least one coating comprises only one binder.

5. The glass sheet of claim 4, wherein the binder is in the form of a sol-gel binder.

6. The glass sheet of claim 1, having at least one of the following features:
in at least one subregion or within the entire at least one region of the at least one side of the glass sheet, a further coating is disposed on the glass sheet;
the at least one coating comprises between at least 15% by weight and at most 55% by weight of binder;
the at least one coating comprises between at least 20% by weight and at most 30% by weight of pigment, based on a sum total of all pigments comprised in the at least one coating;
the glass of the glass sheet has a coefficient of linear thermal expansion of between 2*10⁻⁶/K and 6*10⁻⁶/K;
the glass of the glass sheet comprises at least 60% by weight of SiO₂ to at most 85% by weight of SiO₂ and/or at least 7% by weight of B₂O₃ to at most 26% by weight of B₂O₃;
the at least one coating has a coefficient of linear thermal expansion of between at least 3*10⁻⁶/K and at most 10*10⁻⁶/K; or
the glass sheet has a thickness of between at least 1 mm and at most 12 mm.

7. The glass sheet of claim 1, wherein the at least one coating is microporous in form and/or at most has pores having a maximum lateral dimension of 1 μm.

8. A paste for producing a coating on a glass sheet, the paste comprising:
at least one binder comprising SiO₂, the at least one binder comprising less than 500 ppm of Bi₂O₃ and/or less than 500 ppm of ZnO and/or less than 500 ppm of B₂O₃ and/or less than 500 ppm of an alkali metal oxide, based in each case on weight;
at least one pigment; and
at least one medium.

9. The paste of claim 8, further comprising at least one additive in the form of a filler.

10. The paste of claim 9, having at least one of the following features:
the paste comprises between at least 15% by weight and at most 30% by weight of pigment, based on a total weight of the paste and based on a sum total of the pigments comprised in the paste;
the paste comprises between at least 8% by weight and at most 20% by weight of binder, based on the total weight of the paste;
the paste comprises between at least 10% by weight and at most 40% by weight of additive, based on the total weight of the paste and based on a sum total of the additive comprised in the paste;
the paste comprises a filler having a coefficient of linear thermal expansion of between −10*10⁻⁶/K and +10*10⁻⁶/K; or
the paste comprises up to 50% by weight of a solvent.

11. The paste of claim 8, wherein the at least one binder comprising SiO₂ is in the form of a sol-gel binder, comprising at least one SiO₂ phase crosslinked by hydrolysis and condensation of at least one semi-organic silicon oxide precursor phase, where a semi-organic silicon oxide precursor phase means a silicon compound in which an organic radical is bonded to the silicon atom directly or via an oxygen bridge atom.

12. The paste of claim 11, wherein the organic radial is an alkyl radical.

13. The paste of claim 8, further comprising at least one filler, wherein the at least one filler is or comprises a silica or a lubricant.

14. The paste of claim 13, wherein the at least one filler is present as a lubricant, wherein a ratio of pigment to lubricant is more than 20:1, based on a total weight of a sum total of the pigments comprised in the paste and a sum total of filler in the form of lubricant, based in each case on a weight fraction of the respective constituents.

15. The paste of claim 8, further comprising cellulose.

16. The paste of claim 15, wherein the paste comprises cellulose in an amount of between 0.1% by weight and 1% by weight, based on a total weight of the paste.

17. A laminate, comprising:
a glass sheet comprising:
a glass comprising SiO₂ and B₂O₃; and
at least one coating applied in at least one region of at least one side of the glass sheet, the at least one coating comprising at least one binder comprising SiO₂ and at least one pigment, the at least one coating comprises less than 500 ppm of Bi₂O₃ and/or less than 500 ppm of ZnO and/or less than 500 ppm of B₂O₃ and/or less than 500 ppm of an alkali metal oxide, based in each case on weight; and
a further glass sheet.

18. The laminate of claim 17, wherein the at least one coating is disposed between the glass sheet and the further glass sheet.

19. The laminate of claim 17, wherein the at least one coating comprises at least one additive in the form of a filler.

20. The laminate of claim 17, wherein the glass sheet, in the at least one region which has the applied at least one coating on the at least one side of the glass sheet, has a flexural strength of between at least 80 MPa and at most 300 MPa.
